(19) United States
(12) Patent Application Publication
(10) Pub. No.: US 2013/0201926 A1
(43) Pub. Date: Aug. 8, 2013

(54) SYSTEM AND METHOD FOR PHYSICAL DOWNLINK CONTROL AND HYBRID-ARQ INDICATOR CHANNELS IN LTE-A SYSTEMS

(71) Applicants: Young-Han Nam, Richardson, TX (US); Jianzhong Zhang, Plano, TX (US); Jin-Kyu Han, Allen, TX (US)

(72) Inventors: Young-Han Nam, Richardson, TX (US); Jianzhong Zhang, Plano, TX (US); Jin-Kyu Han, Allen, TX (US)

(73) Assignee: Samsung Electronics Co., Ltd., Suwon-si (KR)

(21) Appl. No.: 13/570,156

(22) Filed: Aug. 8, 2012

Related U.S. Application Data
(60) Provisional application No. 61/522,602, filed on Aug. 11, 2011.
(60) Provisional application No. 61/565,878, filed on Dec. 1, 2011.

(51) Int. Cl. H04W 72/04

(52) U.S. Cl. CPC H04W 72/0406
USPC 370/329

(57) ABSTRACT

A subscriber station configured to receive one or more physical resource blocks (PRBs) from a base station, the PRBs comprising an enhanced physical data control channel (ePDCCH) and at least one of an enhanced physical downlink control format indicator channel (ePCFICH), an enhanced physical hybrid-ARQ indicator channel (ePHICH). A number of resource element groups (REGs) for the at least one of the ePCFICH or the ePHICH are mapped onto a first set of REs in each of one or more PRBs according to a mapping pattern. Also, a number of REGs for the ePDCCH are mapped onto a second set of REs in each of the one or more PRBs, wherein the first set of REs and the second set of REs do not have a common RE.

### CROSS-REFERENCE TO RELATED APPLICATION(S) AND CLAIM OF PRIORITY

The present application is related to U.S. Provisional Patent Application No. 61/522,602, filed Aug. 11, 2011, entitled “ENHANCED PHYSICAL DOWNLINK CONTROL AND HYBRID-ARQ INDICATOR CHANNELS IN LTE-A SYSTEMS” and U.S. Provisional Patent Application No. 61/565,878, filed Dec. 1, 2011, entitled “ENHANCED PHYSICAL DOWNLINK CONTROL AND HYBRID-ARQ INDICATOR CHANNELS IN LTE-A SYSTEMS”. Provisional Patent Application Nos. 61/522,602 and 61/565,878 are assigned to the assignee of the present application and are hereby incorporated by reference into the present application as if fully set forth herein. The present application hereby claims priority under 35 U.S.C. §119(e) to U.S. Provisional Patent Application Nos. 61/522,602 and 61/565,878.

### TECHNICAL FIELD

The present application relates generally to wireless communications, and more particularly, to a system and method for physical downlink control and hybrid-ARQ indicator channels in LTE-A systems.

### BACKGROUND

Modern communications demand higher data rates and performance. Multiple input, multiple output (MIMO) antenna systems, also known as multiple-element antenna (MEA) systems, achieve greater spectral efficiency for allocated radio frequency (RF) channel bandwidths by utilizing space or antenna diversity at both the transmitter and the receiver, or in other cases, the transceiver.

In MIMO systems, each of a plurality of data streams is individually mapped and modulated before being precoded and transmitted by different physical antennas or effective antennas. The combined data streams are then received at multiple antennas of a receiver. At the receiver, each data stream is separated and extracted from the combined signal. This process is generally performed using a minimum mean squared error (MMSE) or MMSE-successive interference cancellation (SIC) algorithm.

In the 3^{rd} Generation Partnership Project (3GPP) LTE release-8 (Rel-8), release-9 (Rel-9), release-10 (Rel-10), physical downlink control channel (PDCCH), physical control format indicator channel (PCFICH) and physical hybrid-ARQ indicator channel (PHICH) are transmitted in the first a few OFDM symbols of each subframe. PDCCHs channels carry downlink control information (DCI) for downlink resource allocation, uplink grant, uplink power control, broadcast signaling resource allocation, paging, and the like.

### SUMMARY

According to one embodiment, a subscriber station configured to receive one or more physical resource blocks (PRBs) from a base station, the PRBs comprising an enhanced physical data control channel (ePDCCH) and at least one of an enhanced physical downlink control format indicator channel (ePCFICH), an enhanced physical hybrid-ARQ indicator channel (ePHICH). A number of resource element groups (REGs) for the at least one of the ePCFICH or the ePHICH are mapped onto a first set of REs in each of one or more PRBs according to a mapping pattern. Also, a number of REGs for the ePDCCH are mapped onto a second set of REs in each of the one or more PRBs, wherein the first set of REs and the second set of REs do not have a common RE.

According to another embodiment, a base station is configured to select one or more physical resource blocks (PRBs) for mapping an enhanced physical data control channel (ePDCCH) and at least one of an enhanced physical downlink control format indicator channel (ePCFICH), an enhanced physical hybrid-ARQ indicator channel (ePHICH). The base station is also configured to map a number of resource element groups (REGs) for the at least one of the ePCFICH or the ePHICH onto a first set of REs in each of one or more PRBs according to a mapping pattern, and map a number of REGs for the ePDCCH onto a second set of REs in each of the one or more PRBs, wherein the first set of REs and the second set of REs do not have a common RE. The one or more PRBs may then be transmitted to at least one subscriber station.

According to another embodiment, a wireless communication method includes receiving one or more physical resource blocks (PRBs) from a base station, the PRBs comprising an enhanced physical data control channel (ePDCCH) and at least one of an enhanced physical downlink control format indicator channel (ePCFICH), an enhanced physical hybrid-ARQ indicator channel (ePHICH). A number of resource element groups (REGs) for the at least one of the ePCFICH or the ePHICH are mapped onto a first set of REs in each of one or more PRBs according to a mapping pattern, and a number of REGs for the ePDCCH are mapped onto a second set of REs in each of the one or more PRBs, wherein the first set of REs and the second set of REs do not have a common RE.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIGS. 2A and 2B illustrate an example orthogonal frequency division multiple access (OFDMA) transmit path and receive path, respectively, according to embodiments of the present disclosure;

FIG. 3 illustrates an example resource element group (REG) according to embodiments of the present disclosure;

FIG. 4 illustrates a CSI-RS-Config information element according to embodiments of the present disclosure;

FIGS. 5A and 5B illustrate example mapping techniques for ePCFICH, ePHICH, and ePDCCH channels on subframe structures according to embodiments of the present disclosure;

FIG. 6A illustrates an example method for mapping ePCFICH/ePDCCH/ePHICH in PRBs according to embodiments of the present disclosure;

FIG. 6B illustrates another example method for mapping ePCFICH/ePDCCH/ePHICH in PRBs according to embodiments of the present disclosure;

FIGS. 7A and 7B illustrate example mapping patterns that may be applied to PRBs configured in subframes according to embodiments of the present disclosure;

FIGS. 8A through 8D illustrate example mapping patterns that may be applied to PRBs configured in subframes according to embodiments of the present disclosure;

FIGS. 9A and 9B illustrate additional example mapping patterns that may be applied to PRBs configured in subframes according to embodiments of the present disclosure;

FIGS. 10A through 10D illustrate additional example mapping patterns that may be applied to PRBs configured in subframes according to embodiments of the present disclosure;

FIGS. 11A and 11B illustrate additional example mapping patterns that may be applied to PRBs configured in subframes according to embodiments of the present disclosure;

FIGS. 12A and 12B illustrate additional example mapping patterns that may be applied to PRBs configured in subframes according to embodiments of the present disclosure;

FIGS. 13A and 13B illustrate additional example mapping patterns that may be applied to PRBs configured in subframes according to embodiments of the present disclosure; and

FIGS. 14A and 14B illustrate example ePDCCH and ePHICH resource numbering schemes according to embodiments of the present disclosure.

### DETAILED DESCRIPTION

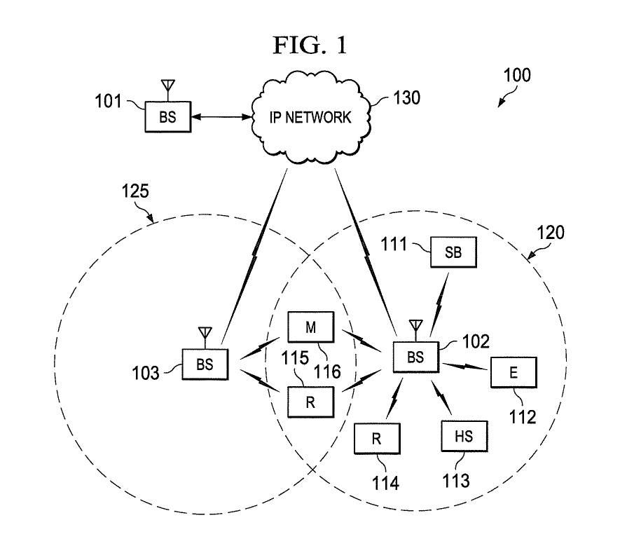

FIGS. 1 through 14B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged image processing system.

The following documents and standards descriptions are hereby incorporated into the present disclosure as if fully set forth herein: REF1—3GPP TS 36.211 v10.1.0, REF2—3GPP TS 36.212 v10.1.0, REF3—3GPP TS 36.213 v10.1.0, and REF4—3GPP TS 36.331 v10.1.0.

With regard to the following description, it is noted that the 3GPP Long Term Evolution (LTE) term “node B” is another term for “base station” used below. Also, the LTE term “user equipment” or “UE” is another term for “subscriber station” (or “SS”) used below.

FIG. 1 illustrates an example wireless network 100 according to embodiments of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Subscriber station (SS) may be any wireless communication device, such as, but not limited to, a mobile phone, mobile PDA and any mobile station (MS). In certain embodiments, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In certain embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In certain embodiments, base stations 101-103 may communicate with each other and with subscriber stations 111-116 using an IEEE-802.16 wireless metropolitan area network standard, such as, for example, an IEEE-802.16e standard. In certain embodiments, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, café, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In certain embodiments, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In certain embodiments, the connection to network 130 may be provided by different network nodes and equipment.

In accordance with an embodiment of the present disclosure, one or more of base stations 101-103 and/or one or more of subscriber stations 111-116 comprises a receiver that is operable to decode a plurality of data streams received as a combined data stream from a plurality of transmit antennas using a minimum mean squared error (MMSE) or MMSE-successive interference cancellation (SIC) algorithm. As described in more detail below, the receiver is operable to determine a decoding order for the data streams based on a decoding prediction metric for each data stream that is calculated based on a strength-related characteristic of the data stream. Thus, in general, the receiver decodes the strongest data stream first, followed by the next strongest data stream, and so on. As a result, the decoding performance of the receiver is improved as compared to a receiver that decodes streams in a random or pre-determined order without being as complex as a receiver that searches all possible decoding orders to find the optimum order.

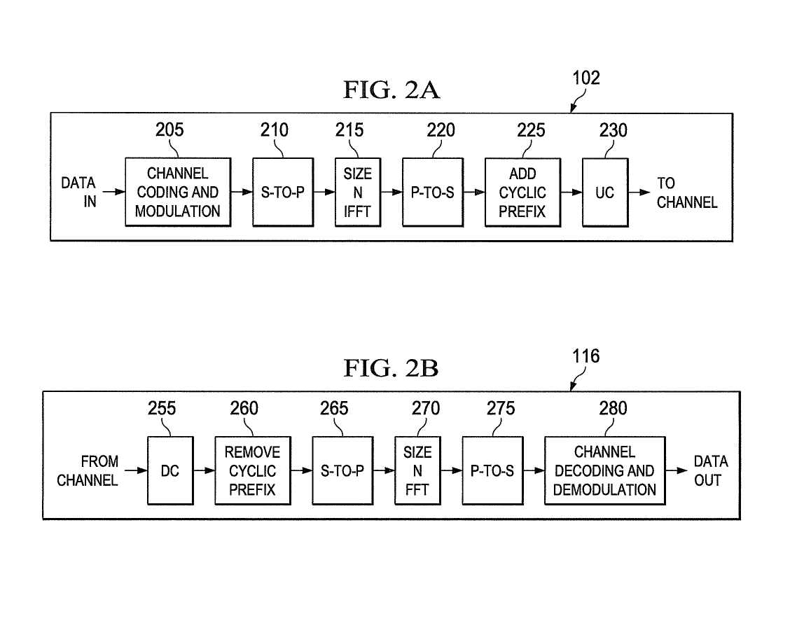

FIGS. 2A and 2B illustrate an example orthogonal frequency division multiple access (OFDMA) transmit path and receive path, respectively, according to certain embodiments of the present disclosure. In FIGS. 2A and 2B, the OFDMA transmit path is implemented in base station (BS) 102 and the OFDMA receive path is implemented in subscriber station (SS) 116 for the purposes of illustration and explanation only. However, it will be understood by those skilled in the art that the OFDMA receive path may also be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 23 may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

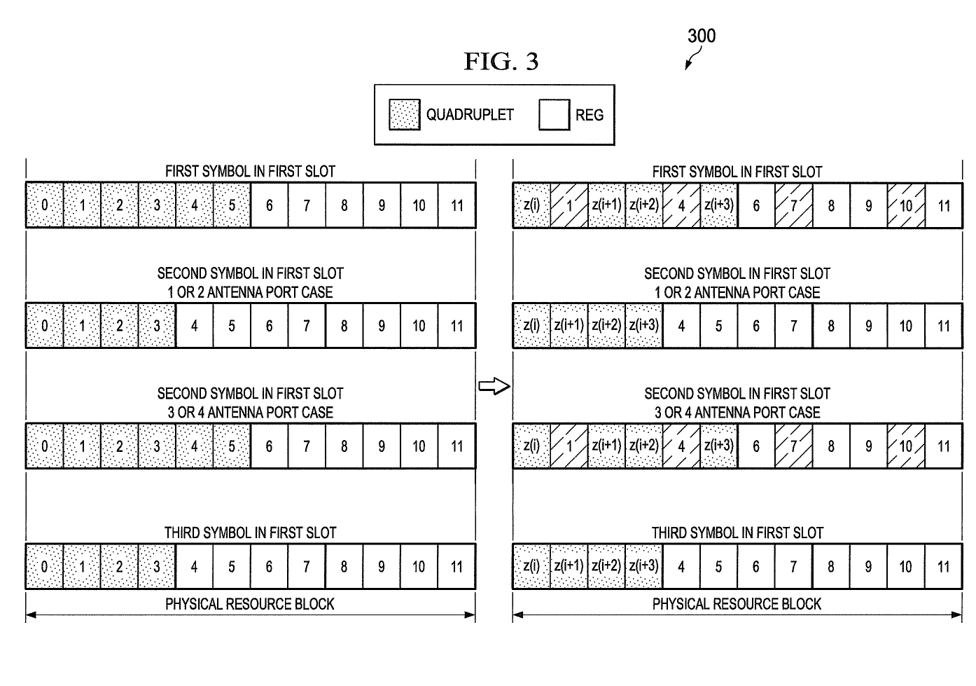

FIG. 3 illustrates an example resource element group (REG) according to certain embodiments of the present disclosure. A resource element group (REG) is basic resource-element (RE) mapping unit for downlink control information. As shown, symbol quadruplets having the form [symbol] z(i),z(i+1),z(i+2),z(i+3) [symbol] may be mapped into REGs. A REG generally includes four consecutive REs in the frequency domain having the same OFDM symbol number. In case some REs are used for a common reference signal (CRS), a REG may be composed of four consecutive non-RS REs (NREGs).

Given a control region size, NREG REGs are formed in a frequency first, time second manner. Then, among those NREG REGs, four REGs are first selected for PCFICH transmission; then 3N_{PHICH}^{group} REGs are selected for PHICH transmissions, where N_{PHICH}^{group} is the number of PHICH groups in the system; then finally the remaining (N_{REG}−4−3N_{PHICH}^{group}) left-over REGs are selected as PDCCH REGs. According to 3GPP LTE release-8 (Rel-8) specifications, cell-specific PHICH/PCFICH resource mapping are selected dependent upon a (physical) cell ID, and the remaining leftover REGs are assigned for PDCCH.

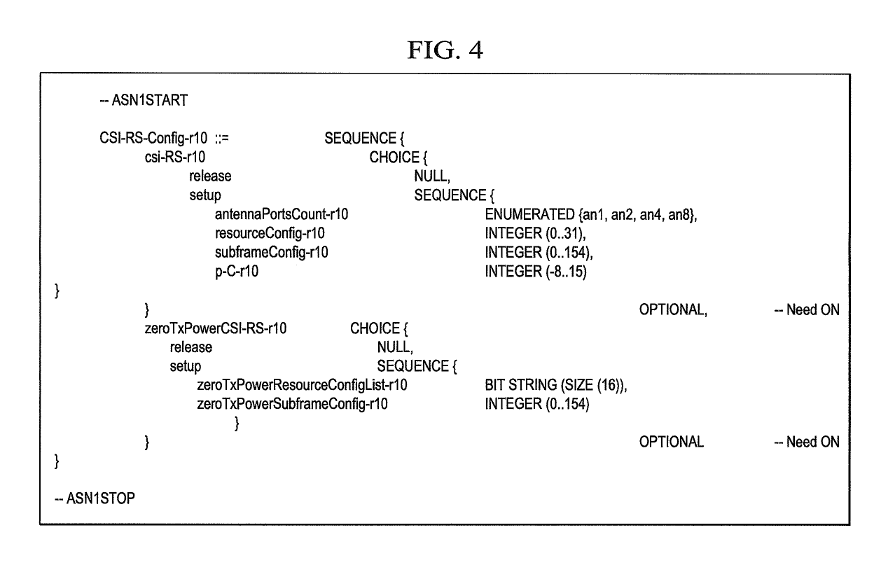

FIG. 4 illustrates a CSI-RS-Config information element (IE) according to certain embodiments of the present disclosure. In the 36.331 v10.1.0 REF4 specification, the CSI-RS-Config IE is used to specify the channel state information (CSI) reference signal configuration. Table 1 lists the various field descriptions used in the CSI-RS-Config IE:

TABLE 1
Field descriptions for CSI-RS-Config IE
CSI-RS-Config field descriptions

antennaPortsCount
Parameter represents the number of antenna ports used for
transmission of CSI reference signals where an1 corresponds to 1,
an2 to 2 antenna ports etc. see TS 36.211 [21, 6.10.5].
p-C
Parameter: P_{c}, see TS 36.213 [23, 7.2.5].
resourceConfig
Parameter: CSI reference signal configuration, see TS 36.211 [21,
table 6.10.5.2-1 and 6.10.5.2-2].
subframeConfig
Parameter: I_{CSI-RS}, see TS 36.211 [21, table 6.10.5.3-1].
zeroTxPowerResourceConfigList
Parameter: ZeroPowerCSI-RS, see TS 36.211 [21, 6.10.5.2].
zeroTxPowerSubframeConfig
Parameter: I_{CSI-RS}, see TS 36.211 [21, table 6.10.5.3-1].

Also, the 36.211 v10.1.0 REF1 specification describes CSI-RS mapping of resource elements. In addition to these parameters, an information field for virtual cell ID in the CSI-RS-Config IE may be included. Possible values for the virtual cell ID are the same as those for the physical cell ID (e.g., 504 values). The virtual cell ID can be used for indicating CSI-RS scrambling initialization. In other words, for a CSI-RS configured together with a virtual cell ID VCID1, a UE may assume that the CSI-RS is scrambled with a scrambling sequence initialized by VCID1, where VCID1 replaces physical cell ID N_{ID}^{cell} in the initialization seed Equation 1:

cᵢₙᵢₜ=2¹⁰·(7·(nₛ+1)+l+1)·(2·N_{ID}^{cell}+1)+2·N_{ID}^{cell}+N_{CP} [Eqn. 1]

In subframes configured for CSI reference signal transmission, the reference signal sequence r_{l,n}_{ₛ}(m) shall be mapped to complex-valued modulation symbols a_{k,l}^{(p)} used as reference symbols on antenna port p according to Equation 2:

$${a}_{k , l}^{( p )} = {w}_{{l}^{″}} \cdot {r}_{l , {n}_{s}} ( {m}^{′} ) \\ where \\ k = {k}^{′} + 12 m + \{ \begin{matrix}- 0 & for p ∈ \{ 15 , 16 \} , normal cyclic prefix \\ - 6 & for p ∈ \{ 17 , 18 \} , normal cyclic prefix \\ - 1 & for p ∈ \{ 19 , 20 \} , normal cyclic prefix \\ - 7 & for p ∈ \{ 21 , 22 \} , normal cyclic prefix \\ - 0 & for p ∈ \{ 15 , 16 \} , extended cyclic prefix \\ - 3 & for p ∈ \{ 17 , 18 \} , extended cyclic prefix \\ - 6 & for p ∈ \{ 19 , 20 \} , extended cyclic prefix \\ - 9 & for p ∈ \{ 21 , 22 \} , extended cyclic prefix\end{matrix} \\ l = {l}^{′} + \{ \begin{matrix}{l}^{″} & \begin{matrix}CSI reference signal configurations 0 \text{-} 19 , \\ normal cyclic prefix\end{matrix} \\ 2 {l}^{″} & \begin{matrix}CSI reference signal configurations 20 \text{-} 31 , \\ normal cyclic prefix\end{matrix} \\ {l}^{″} & \begin{matrix}CSI reference signal configurations 0 \text{-} 27 , \\ extended cyclic prefix\end{matrix}\end{matrix} \\ {w}_{{l}^{″}} = \{ \begin{matrix}1 & p ∈ \{ 15 , 17 , 19 , 21 \} \\ {( - 1 )}^{{l}^{″}} & p ∈ \{ 16 , 18 , 20 , 22 \}\end{matrix} \\ {l}^{″} = 0 , 1 \\ m = 0 , 1 , … , {N}_{RB}^{DL} - 1 \\ {m}^{′} = m + ⌊ \frac{{N}_{RB}^{max , DL} - {N}_{RB}^{DL}}{2} ⌋ \qquad [ Eqn . 2 ]$$

The quantity (k′,l′) and the necessary conditions on nₛ are given by Table 2 for normal cyclic prefix.

TABLE 2
Mapping from CSI reference signal configuration to (k′, l′) for normal cyclic prefix.

| | CSI reference signal | Number of CSI reference signals configured | | | | | |
|---|---|---|---|---|---|---|---|
| | Configuration | 1 or 2 | | 4 | | 8 | |
| | (resourceConfig) | (k′, l′) | nₛ mod 2 | (k′, l′) | nₛ mod 2 | (k′, l′) | nₛ mod 2 |
| Frame | 0 | (9, 5) | 0 | (9, 5) | 0 | (9, 5) | 0 |
| structure | 1 | (11, 2) | 1 | (11, 2) | 1 | (11, 2) | 1 |
| type 1 | 2 | (9, 2) | 1 | (9, 2) | 1 | (9, 2) | 1 |
| and 2 | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| Frame | 20 | (11, 1) | 1 | (11, 1) | 1 | (11, 1) | 1 |
| structure | 21 | (9, 1) | 1 | (9, 1) | 1 | (9, 1) | 1 |
| type 2 | 22 | (7, 1) | 1 | (7, 1) | 1 | (7, 1) | 1 |
| only | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

The cell-specific subframe configuration period T_{CSI-RS} and the cell-specific subframe offset Δ_{CSI-RS} for the occurrence of CSI reference signals are listed in Table 3. The parameter I_{CSI-RS} can be configured separately for CSI reference signals for which the UE shall assume non-zero and zero transmission power. Subframes containing CSI reference signals shall satisfy (10n_{f}+└nₛ/2┘−Δ_{CSI-RS})mod T_{CSI-RS}=0.

TABLE 3
CSI reference signal subframe configuration

| | | CSI-RS |
|---|---|---|
| | | subframe offset |
| CSI-RS- | CSI-RS periodicity T_{CSI-RS} | Δ_{CSI-RS} |
| SubframeConfig I_{CSI-RS} | (subframes) | (subframes) |
| 0-4 | 5 | I_{CSI-RS} |
| 5-14 | 10 | I_{CSI-RS}-5 |
| 15-34 | 20 | I_{CSI-RS}-15 |
| 35-74 | 40 | I_{CSI-RS}-35 |
| 75-154 | 80 | I_{CSI-RS}-75 |

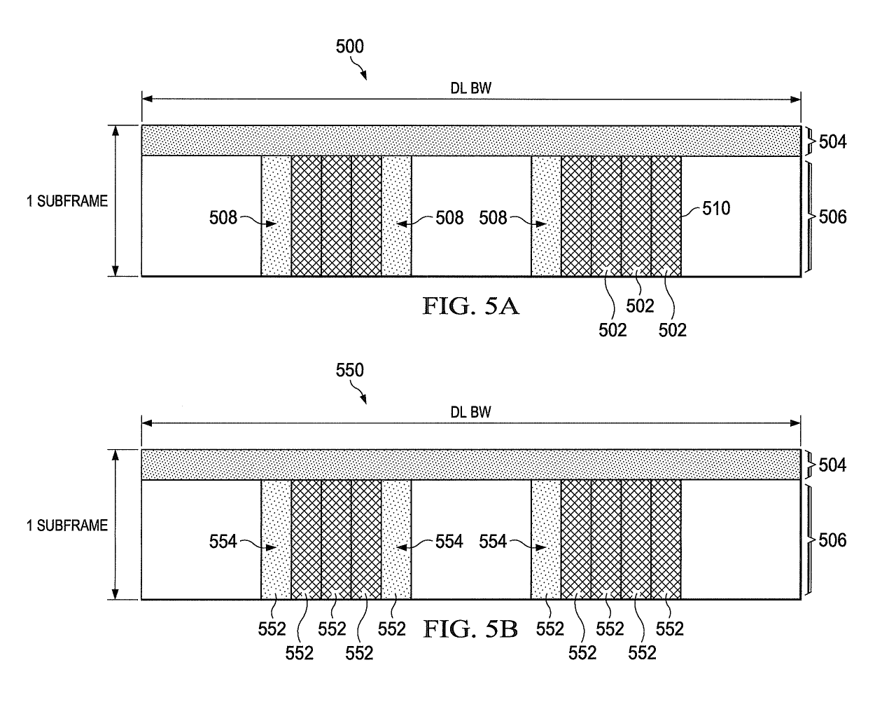

FIGS. 5A and 5B illustrate example mapping techniques for PCFICH, PHICH, and PDCCH channels on subframe structures according to embodiments of the present disclosure. Within this disclosure, the PCFICH, PHICH, and PDCCH channels may be referred to as enhanced PCFICH (ePCFICH), enhanced PHICH (ePHICH), and enhanced PDCCH (ePDCCH). As will be described in detail below, certain embodiments of the ePCFICH, ePHICH, and ePDCCH structures may increase downlink (DL) control capacity within a cell and for mitigate inter-cell interference for DL control.

As shown in FIG. 5A, a subframe 500 includes a number of resource elements arranged along a number of sub-carriers 502 and a number of symbols arranged in a m×n configuration. The subframe 500 also includes a ePDCCH region 504 and a PDSCH region 506. The ePHICH/ePCFICH PRBs 508 may be multiplexed into PRBs of the subframe 500 separately from e-PDCCH PRBs 510. Thus as shown, ePDCCH is not multiplexed with ePCFICH/ePHICH in the same PRB.

A base station may select one or more PRBs for mapping an ePDCCH and at least one of an ePCFICH and an ePHICH and transmit the PRBs to subscriber stations within its cell. The selected PRBs selected by the base station may include a number of resource element groups (REGs) for the selected ePCFICH or the ePHICH mapped onto a first set of REs having a specified type of mapping pattern. Additionally, the selected PRBs selected by the base station may include a number of REGs for the ePDCCH mapped onto a second set of REs in each of the one or more PRBs.

The ePHICH, ePCFICH, and ePDCCH PRBs may exhibit certain characteristics. In an ePDCCH PRB, among the three downlink control channels, only ePDCCH is transmitted. In an ePCFICH/ePHICH PRB, among the three DL control channels, either ePCFICH or ePHICH or both can be transmitted, while ePDCCH is not transmitted. In an ePCFICH/ePHICH/ePDCCH PRB, any combination of the three DL control channels can be transmitted. Furthermore, one set of PRBs is configured for ePCFICH and ePHICH while four sets of PRBs, are configured for ePDCCH. For example, two separate RRC signaling messages can be sent for these two configurations. On every PRB configured with ePCFICH and ePHICH, at least one ePCFICH REG and/or at least one ePHICH REG are mapped.

A 2-bit ePCFICH determines one selected set out of the PRBs allocated to ePDCCH. When a UE detects ePCFICH, the UE receives ePDCCH within the selected set. For example, the 2-bit ePCFICH indicates a particular PRB. Given this information, a UE having correctly read the ePCFICH searches its ePDCCH in a subset of PRBs. In this case, the base station has placed the UE's ePDCCH in the subset of PRBs.

In certain embodiments, a base station configures a UE to read ePCFICH in the subframe, where ePCFICH is used for dynamically configuring ePDCCH/ePHICH PRBs in a subframe. For example, when four sets of ePDCCH/ePHICH PRBs are configured to a UE, the UE reads a 2-bit information from ePCFICH in the subframe and identifies one set out of four sets of ePDCCH/ePHICH PRBs to read ePDCCH/ePHICH.

The technique as shown in FIG. 5A may have the following characteristics: ePDCCH RE mapping does not change over PRBs, and a separate RSs can be easily provisioned for ePHICH. Nevertheless, a relatively large fixed overhead may be incurred for ePHICH transmission using this technique in some embodiments.

FIG. 5B depicts a subframe 550 including includes a number of resource elements arranged along a number of sub-carriers 552 and a number of symbols arranged in a m×n configuration in a similar manner as shown in FIG. 5A. However, ePHICH PRBs, ePCFICH PRBs, and ePDCCH PRBs may be multiplexed into common PRBs 554 of the subframe 500. Furthermore, four sets of PRBs are configured for ePCFICH/ePDCCH/ePHICH, for example, for radio resource control (RRC) signaling.

In some cases, on every PRB of the common PRBs 554, at least one ePCFICH REG and/or at least one ePHICH REG are mapped.

A 2-bit ePCFICH determines one selected PRB. When a UE detects ePCFICH, the UE receives ePDCCH within the selected set. In one example, the 2-bit ePCFICH indicates a particular PRB. Then, a UE having correctly read the ePCFICH searches its ePDCCH in a subset of the PRBs. In this case, the base station has placed the UE's ePDCCH in that particular subset of PRBs.

The technique as shown in FIG. 5B may have the following characteristics: ePDCCH/ePHICH PRBs can be flexibly used for ePDCCH and PDSCH by base station scheduling, and a relatively small fixed overhead is introduced for ePHICH transmission. Nevertheless, ePDCCH/PDSCH RE mapping may change over different types of PRBs.

In the particular embodiment as illustrated in FIG. 5B, ePDCCH can be multiplexed with ePCFICH/ePHICH in the same PRB. Furthermore, one set of PRBs may be configured for ePCFICH and ePHICH while four sets of PRBs may be configured for ePDCCH. For example, two separate RRC signaling messages can be sent using these two configurations.

On every PRB of the common PRBs 554, at least one ePCFICH REG and/or at least one ePHICH REG may be mapped. In some cases, one particular PRB is equivalent to another particular PRB, which is a subset of the intersection of the other PRBs.

A 2-bit ePCFICH value determines one selected PRB. When a UE detects ePCFICH, the UE may then receive the appropriate ePDCCH within the selected set. In one example, the 2-bit ePCFICH indicates a particular PRB, then, the UE having correctly read the ePCFICH searches its ePDCCH in a subset of PRBs. In this case, the base station has placed the UE's ePDCCH in the subset of PRBs.

According to certain embodiments, the following procedure may be used for mapping ePCFICH/ePDCCH/ePHICH in PRBs. First, all the non-RS REs are sequentially numbered in a subcarrier-first (e.g., frequency-first), time-second manner. Then, REGs are formed by four of those adjacent numbered REs, from the smallest numbered non-RS RE. If ePCFICH is configured, among those REGs, N1 REGs are selected as ePCFICH REGs. If ePHICH is configured, among those REGs, N2 REGs are selected as ePHICH REGs. The remaining REGs are then configured as ePDCCH REGs. When PDSCH is scheduled in the PRB, a UE assumes rate matching around ePCFICH and ePHICH as well as RS.

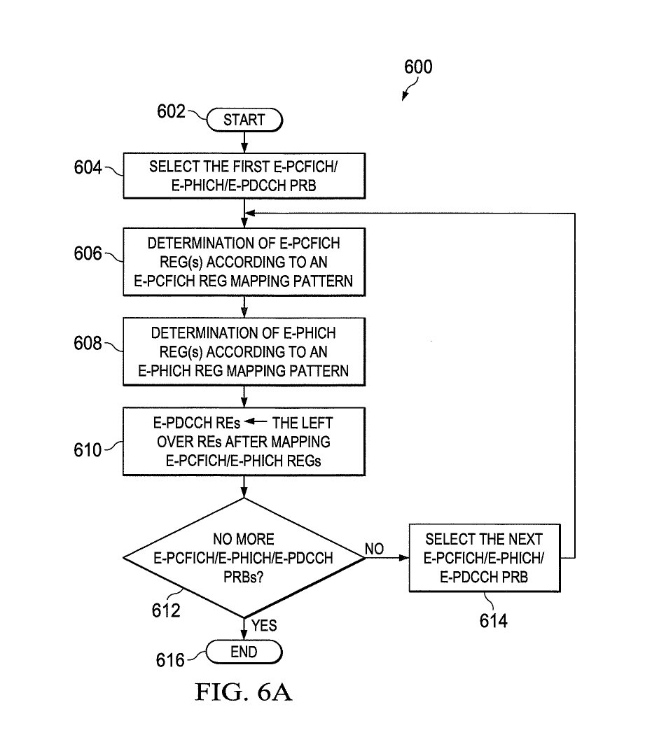

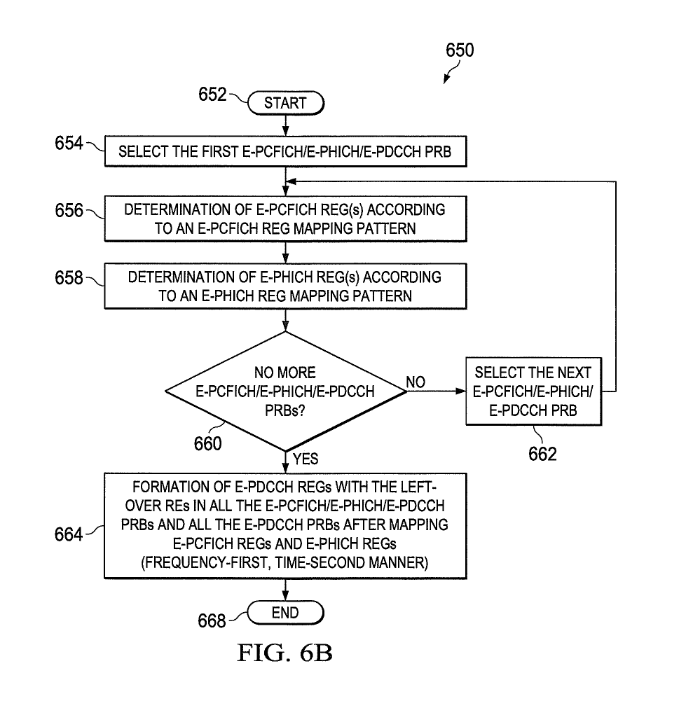

FIG. 6A illustrates an example method 600 for mapping ePCFICH/ePDCCH/ePHICH in PRBs according to certain embodiments of the present disclosure. In step 602 the process is initiated.

In step 604, the first PRB from among all ePCFICH/ePDCCH/ePHICH PRBs are selected. In step 606, if ePCFICH is to be configured, ePCFICH REs are firstly mapped into the PRB according to an ePCFICH REG mapping pattern. In step 608, if ePHICH is to be configured, ePHICH REs are mapped after the ePCFICH mapping according to an ePHICH REG mapping pattern. In step 610, ePDCCH REs are implicitly determined (e.g., frequency-first, time-second) with the remaining left-over REs, CSI-RS/muting, CRS, UE-RS.

In step 612, it is determined if additional PRBs are to be determined. If additional PRBs are to be mapped, processing continues at step 614 to select the next PRB. However, if no additional PRBs are to be mapped, processing is terminated at step 616.

FIG. 6B illustrates another example method 650 for mapping ePCFICH/ePDCCH/ePHICH in PRBs according to certain embodiments of the present disclosure. In step 652 the process is initiated.

In step 654, the first PRB from among all ePCFICH/ePDCCH/ePHICH PRBs are selected. In step 656, if ePCFICH is configured, ePCFICH REGs are firstly mapped into each ePCFICH/ePHICH/ePDCCH PRB according to an ePCFICH REG mapping pattern. In step 658, if ePHICH is configured, ePHICH REGs are mapped into each ePCFICH/ePHICH/ePDCCH PRB after the ePCFICH mapping according to an ePHICH REG mapping pattern.

In step 660, it is determined if additional ePCFICH or ePHICH PRBs are to be mapped. If so, processing continue at step 662 to select the next PRB. However, if not additional ePCFICH/ePHICH PRBs are to be mapped, processing continues at step 664 in which ePDCCH REGs are formed with the remaining REs in all the ePCFICH/ePHICH/ePDCCH PRBs and all the ePDCCH PRBs, starting from the top-left RE (e.g., frequency-first, time-second) after excluding the other E-CCHs, CSI-RS/muting, CRS, UE-RS. When PDSCH is scheduled in the PRB, a UE assumes rate matching around ePCFICH and ePHICH as well as RS.

When processing at step 664 is completed, processing continue at step 668 in which the process is terminated.

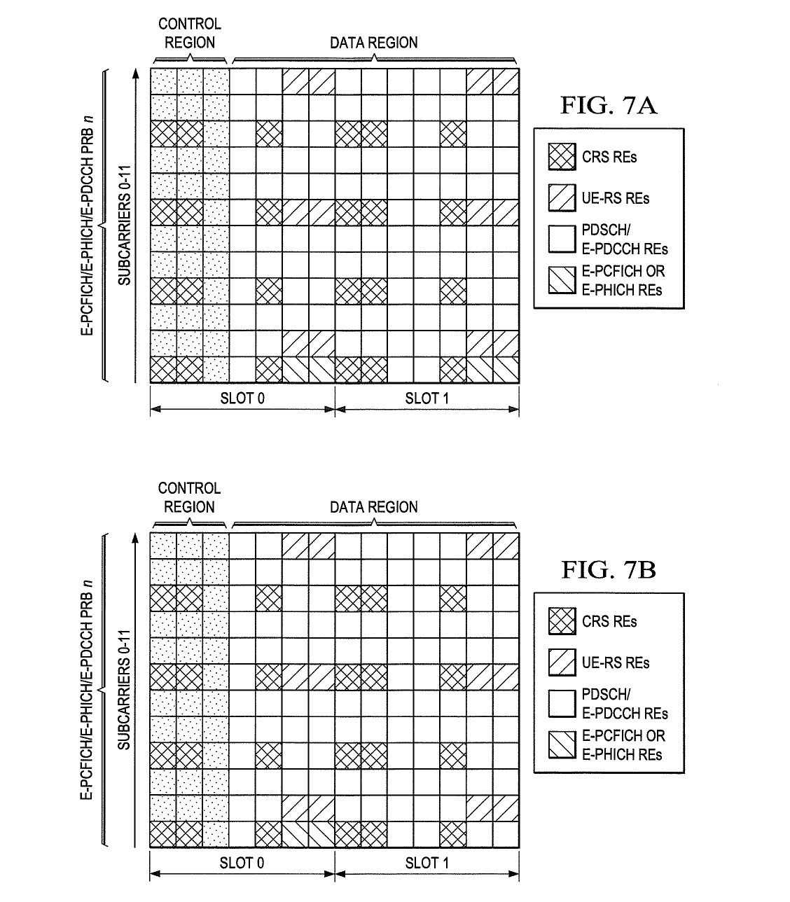

FIGS. 7A and 7B illustrate example mapping patterns that may be applied to PRBs configured in subframes according to embodiments of the present disclosure. As shown, ePCFICH and ePHICH REs are selected from non-RS REs (i.e., excluding DM-RS and CSI-RS) on the OFDM symbols with DM-RS (e.g., OFDM symbols 5 and 6 in both slots in normal cyclic prefix (CP) subframes). N subcarriers are selected for ePCFICH and ePHICH mapping per each ePCFICH, ePHICH, and ePDCCH PRBs. In the particular examples shown in FIGS. 7A and 7B, N=1. Additionally, one subcarrier on the bottom is selected OFDM symbols with DM-RS in the first slot (FIG. 7A) or in both slots (FIG. 7B) for ePCFICH/ePHICH mapping.

In certain embodiments, the ePCFICH and the ePHICH each have a REG size that is either larger or smaller than the REG size of the ePDCCH. In certain embodiments, REs on those selected subcarriers only in one slot are used for ePCFICH/ePHICH mapping. In this case, 2N REs are selected for the ePCFICH/ePHICH mapping. In certain embodiments, REs on those selected subcarriers in both slots are used for ePCFICH/ePHICH mapping. In this case, 4N REs are selected for the ePCFICH/ePHICH mapping. The remaining non-RS subcarriers after ePHICH/ePCFICH can be used for ePDCCH mapping. Considering that ePDCCH REGs are formed by adjacent non-RS REs in frequency domain, it would be beneficial to determine N such that the number of remaining non-RS subcarriers is divisible by four in the event that ePDCCH REG size is four or two in the event that ePDCCH REG size is two.

In FIGS. 7A and 7B, it is assumed that no CSI-RS are transmitted in the OFDM symbols with DM-RS, and hence nine subcarriers are available for ePCFICH/ePHICH mapping. By selecting one subcarrier for ePCFICH/ePHICH mapping, the remaining number of available non-RS subcarriers is eight, which is divisible by four and two.

The subcarrier locations within each PRB for ePHICH/ePCFICH mapping can be selected from the following subcarriers: subcarriers with UE-RS CDM set 2, i.e., UE-RS REs where UE-RS ports 9 and 10 are mapped, subcarriers 0, 5 and 10 in case of normal CP subframes, subcarriers on which no CSI-RS can be placed, subcarriers 4 and 7 in case of normal CP subframes.

ePHICH/ePCFICH REG size can be one, two, or four. When the REG size is two, two adjacent REs in time domain would form a REG. On the other hand, when the REG size is four, four ePHICH/ePCFICH REs on the same subcarrier in FIG. 7A could form one REG, for example.

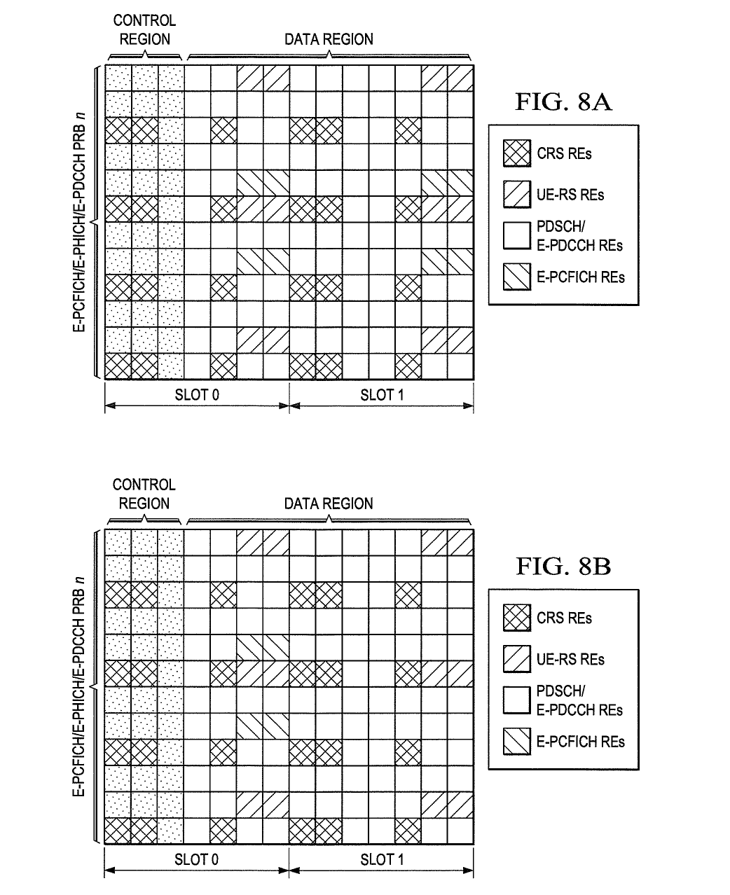

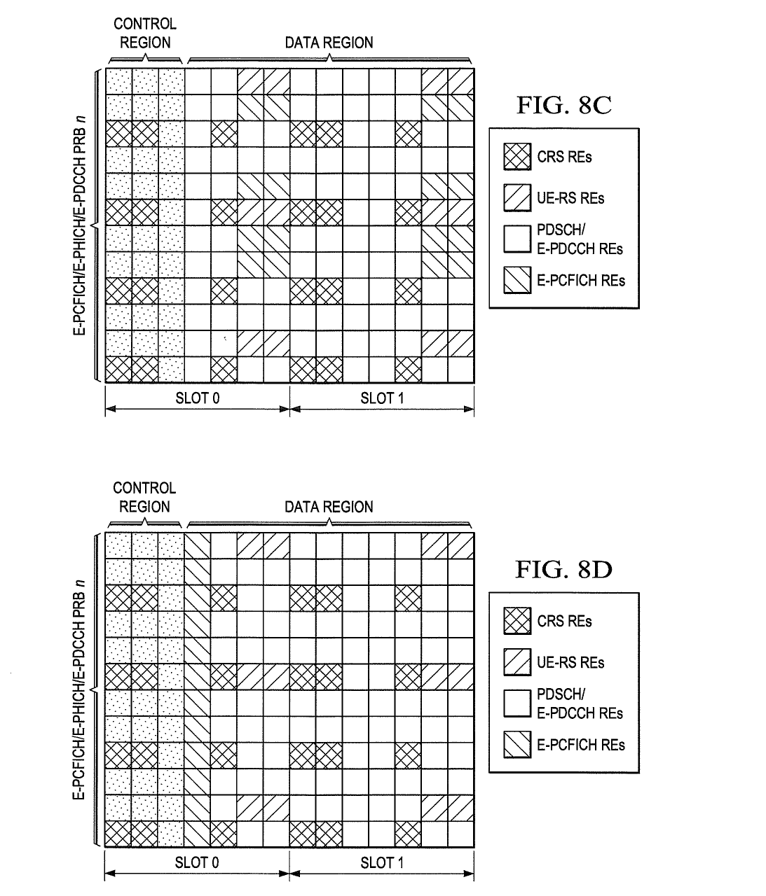

FIGS. 8A through 8D illustrate example mapping patterns that may be applied to PRBs configured in subframes according to embodiments of the present disclosure. In certain embodiments, in each PRB on which ePCFICH is mapped, ePCFICH is mapped only onto those PDSCH REs in OFDM symbols without CRS which cannot be used as control OFDM symbols (e.g., OFDM symbols 4 and above in the first time slot and all the OFDM symbols in the second slot), on which no RS (including UE-RS APs 7, 8, 9, 10 and CSI-RS all APs according to any configurations) can be mapped. One particular benefit of this approach is that the ePCFICH mapping does not change depending on the configured CSI-RS pattern.

As shown in FIG. 8A, the ePCFICH mapping pattern is generated under the principle of using all the aforementioned non-RS PDSCH REs for ePCFICH. In certain embodiments, the ePCFICH REG size is four. For example, an ePCFICH REG is composed of four REs on the same subcarrier. For another example, an ePCFICH REG is composed of four REs in the two adjacent OFDM symbols. In certain embodiments, the ePCFICH REG size is two. For example, an ePCFICH REG is composed of two REs adjacent to each other on the same subcarrier.

As shown in FIG. 8B, the ePCFICH mapping pattern is generated under the principle of using a subset of the aforementioned non-RS PDSCH REs placed in the first slot for ePCFICH. In certain embodiments, the ePCFICH REG size is four, and an ePCFICH REG is composed of four REs in the two adjacent OFDM symbols. In certain embodiments, the ePCFICH REG size is two, and an ePCFICH REG is composed of two REs adjacent to each other on the same subcarrier.

The example mapping scheme shown in FIG. 8B may, in some embodiments, be particularly beneficial when CRS includes demodulation pilots for ePCFICH. Another benefit of this example mapping is that a UE need to buffer only the first time slot for demodulating ePCFICH.

As shown in FIG. 8C, in each PRB on which ePCFICH is mapped, ePCFICH is mapped only onto those PDSCH REs in OFDM symbols without CRS which cannot be used as control OFDM symbols (e.g., OFDM symbols 4 and above in the first time slot and all the OFDM symbols in the second slot), on which no RS (including UE-RS APs 7, 8 and CSI-RS antenna ports (APs) according to any configurations) can be mapped. However, PCFICH may be mapped onto those REs that can be used for UE-RS APs 9,10. According to these principles, ePCFICH can only be mapped onto those non-RS REs on the OFDM symbols with UE-RS, where the possible subcarrier locations for the ePCFICH are further restricted to subcarriers 0, 5, 4, 7, 10 in normal CP subframes. The general principle is to use a subset of the aforementioned PDSCH REs for ePCFICH. One main benefit of this approach is that the ePCFICH mapping does not change depending on the configured CSI-RS pattern. As shown, ePCFICH mapping is in both slots.

In certain embodiments, ePCFICH REG size is four. For example, an ePCFICH REG is composed of four REs on the same subcarrier. For certain embodiments, an ePCFICH REG is composed of four REs on the same OFDM symbol. For yet another example, ePCFICH REGs are formed from top subcarrier to bottom subcarrier, where the four REs are characterized by two adjacent OFDM symbols and two closest subcarriers on which ePHICH is mapped.

In certain embodiments, ePCFICH REG size is two. In this case, two adjacent ePCFICH REs would form one ePCFICH REG. It may be contemplated that a variant mapping pattern of FIG. 8C where only the first slot has ePCFICH REs in other embodiments.

As shown in FIG. 8D, in each PRB on which ePCFICH is mapped, the REs in the OFDM symbol adjacent to the control region in the first time slot is used for ePCFICH mapping. As shown, the control region includes the 1^{st} through the 3^{rd} OFDM symbol, and ePCFICH is mapped onto the 4th OFDM symbol. When the ePCFICH REG size is four, ePCFICH REGs are formed by four adjacent REs in the subcarrier domain. When the ePCFICH REG size is two, ePCFICH REGs are formed by two adjacent REs in the subcarrier domain.

Certain embodiments of this mapping scheme may be beneficial when CRS includes demodulation pilots for ePCFICH, and that a UE need to buffer only up to the 4th OFDM symbol for demodulating PCFICH.

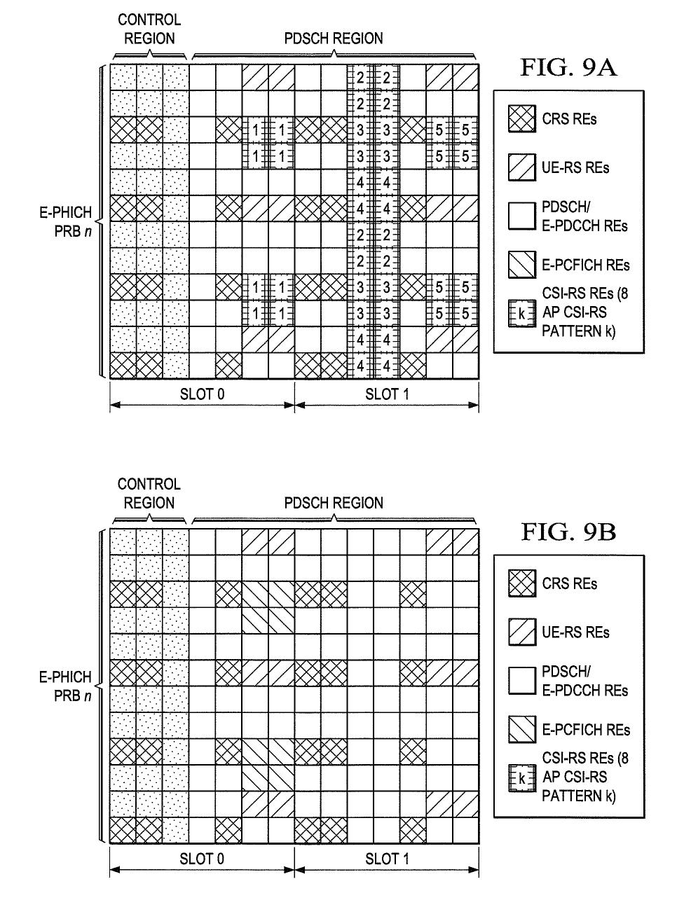

FIGS. 9A and 9B illustrate additional example mapping patterns that may be applied to PRBs configured in subframes according to embodiments of the present disclosure.

In each PRB on which ePCFICH is mapped, ePCFICH REs are configured based on N_{AP}-port CSI-RS patterns conforming to the 3rd Generation Partnership Project (3GPP) LTE Release-10 specification in each of the one or more PRBs. When a UE is configured with an N_{AP}-port CSI-RS pattern for ePCFICH, the UE receives ePCFICH (instead of CSI-RS) in those CSI-RS REs identified by the N_{AP}-port CSI-RS pattern. For example, ePCFICH REs are configured based on 8-port CSI-RS patterns. According to the Rel-10 specification, five 8-port CSI-RS patterns may be defined. The ePCFICH REG mapping pattern can be configured via an RRC bitmap signaling. As up to five different 8-port CSI-RS patterns are available in each PRB as shown in FIG. 9A, a 5-bit bitmap signaling may be used. A bit set in position i of the bitmap signaling indicates that the i-th 8-port CSI-RS pattern is used for ePCFICH REG mapping, where i ε{0, 1, 2, 3, 4} indicates an i-th 8-port CSI-RS pattern according to Table 1 with resourceConfig i. For example, when a bitmap of [1 0 0 0 0] is RRC signaled for ePCFICH REG mapping pattern, then a UE identifies a ePCFICH REG mapping pattern of FIG. 9B. In this case, ePCFICH REGs are formed by four of those selected REs which are next to each other in time and frequency domain. Some benefits of this example design are listed below.

ePCFICH RE location is identical to at least one 8 CSI-RS pattern. This property may simplify UE ePCFICH receiver design, as a UE may implement a single ePCFICH receiver based on only one base ePCFICH REG pattern of 2×2 grid. The de-spreading receiver performance is likely to be the best as an ePCFICH REG is composed of the four closest REs in a 2×2 grid in the time and frequency domain. ePCFICH REGs are closely located to CRS in the control region, which is beneficial when CRS is used for demodulating ePCFICH. This technique may, in some cases, guarantee not to use REs in the same OFDM symbol as CRS for ePCFICH REG mapping.

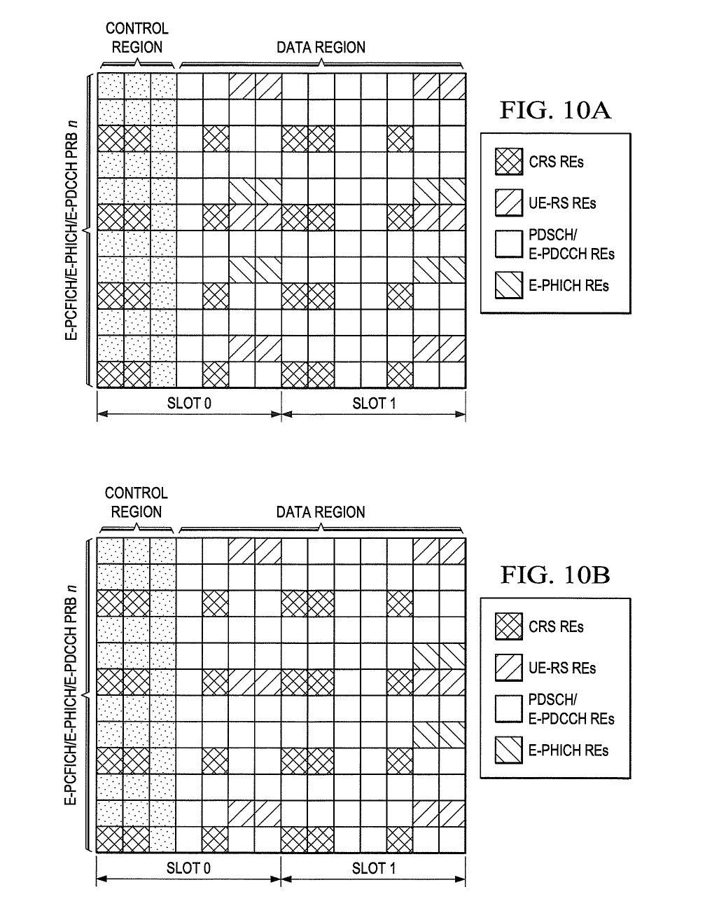

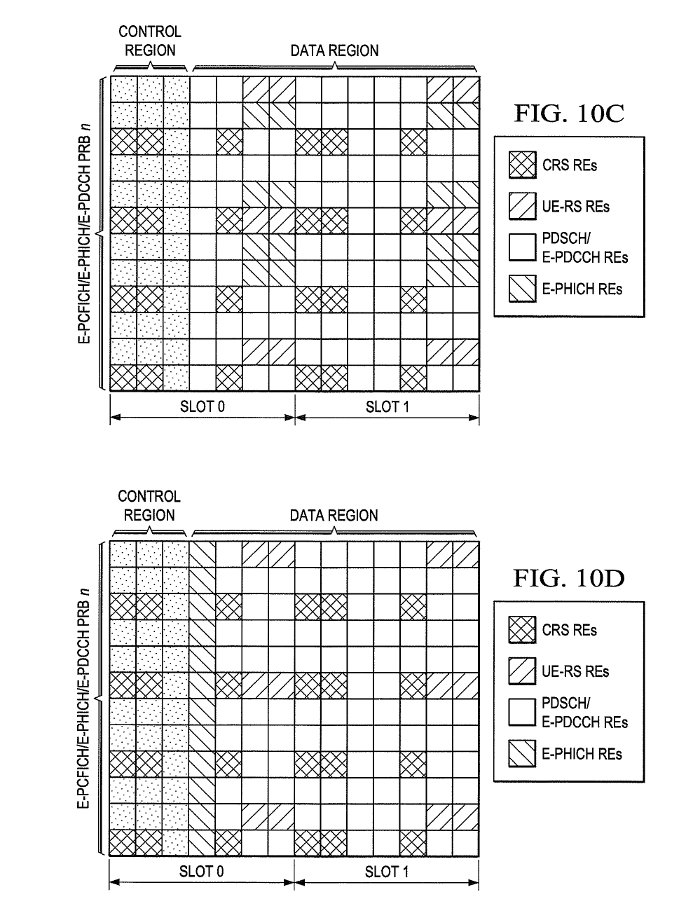

FIGS. 10A through 10D illustrate additional example mapping patterns that may be applied to PRBs configured in subframes according to embodiments of the present disclosure.

In each PRB on which ePHICH is mapped, ePHICH is mapped only onto those PDSCH REs in OFDM symbols without CRS which cannot be used as control OFDM symbols (e.g., OFDM symbols 4 and above in the first time slot and all the OFDM symbols in the second slot), on which no RS (including UE-RS APs 7, 8, 9, 10 and CSI-RS all APs according to any configurations) can be mapped. According to these principles, ePHICH can only be mapped onto those non-RS REs on the OFDM symbols with UE-RS, where the possible subcarrier locations for the ePHICH are further restricted to subcarriers 4 and 7 in normal CP subframes. Certain embodiments of this technique may provide a benefit in that the ePHICH mapping does not change depending on the configured CSI-RS pattern.

The ePHICH mapping pattern in FIG. 10A is generated under the principle of using all the aforementioned non-RS PDSCH REs for ePHICH. In certain embodiments, the ePHICH REG size is four. In certain embodiments, an ePHICH REG is composed of four REs on the same subcarrier. In certain embodiments, an ePHICH REG is composed of four REs in the two adjacent OFDM symbols. In certain embodiments, the ePHICH REG size is two. For example, an ePHICH REG is composed of two REs adjacent to each other on the same subcarrier.

The ePHICH mapping pattern in FIG. 10B is generated under the principle of using a subset of the aforementioned non-RS PDSCH REs placed in the second slot for each ePHICH. In certain embodiments, the E-PHICH REG size is four, and an ePHICH REG is composed of four REs in the two adjacent OFDM symbols. In certain embodiments, the ePHICH REG size is two, and an ePHICH REG is composed of two REs adjacent to each other on the same subcarrier. Certain embodiments of this technique may be beneficial in that ePHICH may be multiplexed in the same PRB as ePCFICH, where ePCFICH is placed in the first slot for faster decoding and for buffer size reduction.

As shown in FIG. 10C, in each PRB on which ePHICH is mapped, ePHICH is mapped only onto those PDSCH REs in OFDM symbols without CRS which cannot be used as control OFDM symbols (e.g., OFDM symbols 4 and above in the first time slot and all the OFDM symbols in the second slot), on which no RS (including UE-RS APs 7, 8 and CSI-RS all APs according to any configurations) can be mapped. However, PCFICH may be mapped onto those REs that can be used for UE-RS APs 9 and 10. According to these principles, ePHICH can only be mapped onto those non-RS REs on the OFDM symbols with UE-RS, where the possible subcarrier locations for the ePHICH are further restricted to subcarriers 0, 4 5, 7 and 10 in normal CP subframes. The general principle is to use a subset of the aforementioned PDSCH REs for ePHICH. One main benefit of this approach is that the ePHICH mapping does not change depending on the configured CSI-RS pattern.

In certain embodiments, the ePHICH REG size is four. For example, an ePHICH REG is composed of four REs on the same subcarrier. In another example, an ePHICH REG is composed of four REs on the same OFDM symbol. In another example, ePHICH REGs are formed from the top subcarrier to the bottom subcarrier, where the four REs are characterized by two adjacent OFDM symbols and two closest subcarriers on which ePHICH is mapped.

In certain embodiments, the ePHICH REG size is two. In this case, two adjacent ePHICH REs would form an ePHICH REG. It may be contemplated that a variant mapping pattern of FIG. 10C in which only the first slot has ePHICH REs may be implemented.

As shown in FIG. 10D, in each PRB on which ePHICH is mapped, the REs in the OFDM symbol adjacent to the control region in the first time slot are used for ePHICH mapping. As shown, the control region is up to the 3rd OFDM symbol, and ePHICH is mapped onto the 4th OFDM symbol. When the ePHICH REG size is four, ePHICH REGs are formed by four adjacent REs in the subcarrier domain. When the ePHICH REG size is two, ePHICH REGs are formed by two adjacent REs in the subcarrier domain. Certain embodiments of this mapping may be beneficial when CRS includes demodulation pilots for ePHICH. Another benefit of this mapping scheme may be that a UE need to buffer only up to the 4th OFDM symbol for demodulating PCFICH.

In embodiments, in each PRB on which ePHICH is mapped, ePHICH REs are configured based on N_{AP}-port CSI-RS patterns. When a UE is configured with an N_{AP}-port CSI-RS pattern for ePHICH, the UE receives ePHICH (instead of CSI-RS) in those CSI-RS REs identified by the N_{AP}-port CSI-RS pattern.

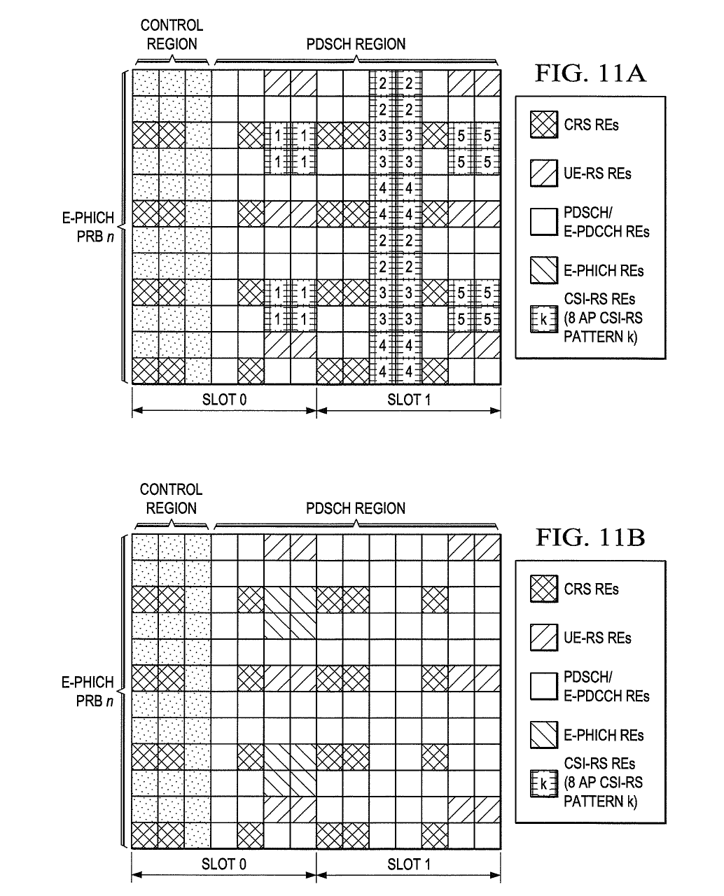

FIGS. 11A and 11B illustrate additional example mapping patterns that may be applied to PRBs configured in subframes according to embodiments of the present disclosure. FIG. 10A shows ePHICH REs which are configured based on 8-port CSI-RS patterns. According to the Rel-10 specification, five 8-port CSI-RS patterns are defined. As shown in FIG. 11A, however, the ePHICH REG mapping pattern can be configured via an RRC bitmap signaling as up to five different 8-port CSI-RS patterns are available in each PRB. Thus, a five-bit bitmap signaling may be used. A bit set in position i of the bitmap signaling indicates that the i-th 8-port CSI-RS pattern is used for ePHICH REG mapping, where i ε{1, 2, 3, 4} indicates an i-th 8 port CSI-RS pattern according to Table 1 with resourceConfig i. For example, when a bitmap of [1 0 0 0 0] is RRC signaled for ePHICH REG mapping pattern, then a UE identifies a ePHICH REG mapping pattern of FIG. 11B. In this case, ePHICH REGs are formed by either four of those selected REs which are next to each other in time and frequency domain. Some benefits of this example design are listed below or 2 of those selected REs adjacent to each other in time or frequency domain.

ePHICH RE location is identical to at least one 8 CSI-RS pattern. This property may simplify UE ePHICH receiver design, as a UE may implement a single ePHICH receiver based on only one base ePHICH REG pattern of 2×2 grid. The de-spreading receiver performance is likely to be the best as an ePHICH REG is composed of the four closest REs in the 2×2 grid in the time and frequency domain. The ePHICH REGs are closely located to CRS in the control region, which may be beneficial when CRS is used for demodulating ePHICH. In some cases, this technique may guarantee not to use REs in the same OFDM symbol as CRS for ePHICH REG mapping.

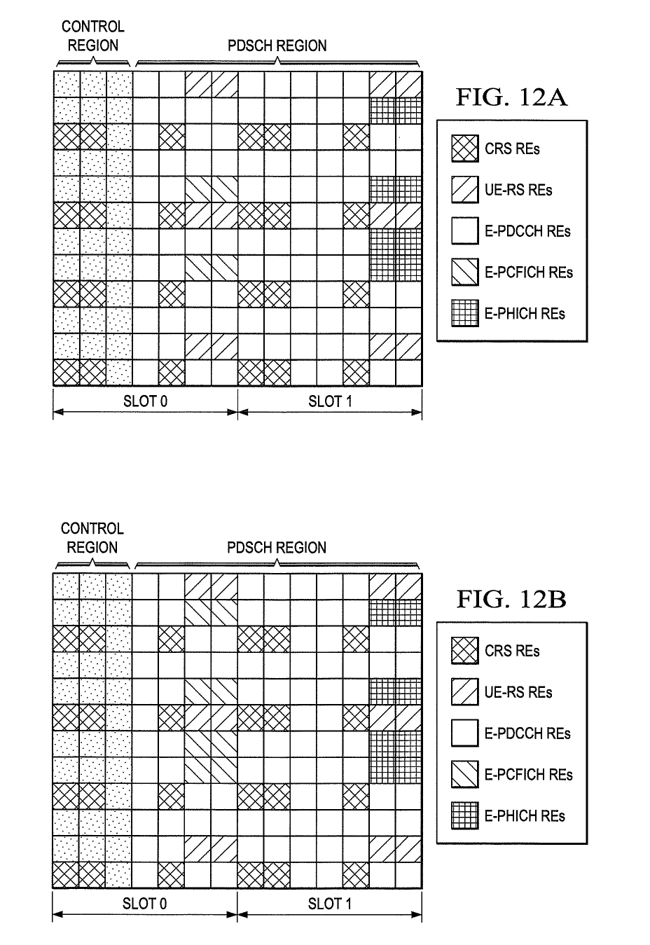

FIGS. 12A and 12B illustrate additional example mapping patterns that may be applied to PRBs configured in subframes according to embodiments of the present disclosure.

As shown, ePHICH, ePCFICH and ePDCCH are multiplexed in the same PRB, where the principle is to place ePCFICH REGs in the first time slot and ePHICH in the second time slot. This is for facilitating a simple implementation with smaller buffer size for demodulating ePCFICH, and at the same time to efficiently utilize the resources by placing ePHICH in the second time slot as UE action followed by successfully decoded ePHICH happens in a few subframes later (in case of FDD, 4 subframes later). After placing ePCFICH and ePHICH, all the other remaining non-RS non-control REs can be used as ePDCCH or PDSCH REs.

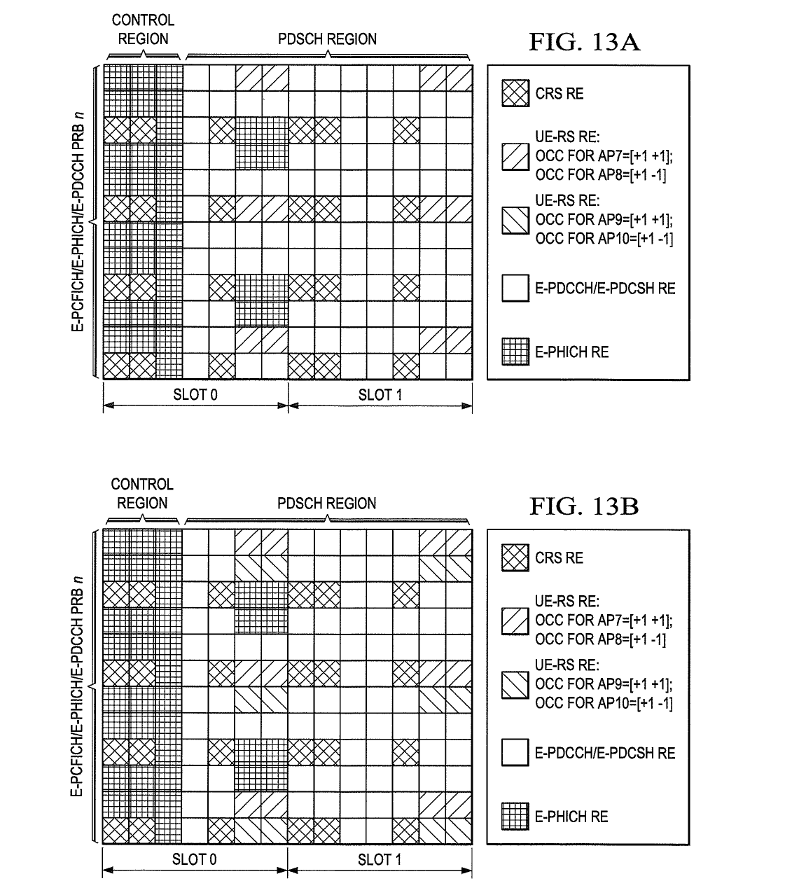

FIGS. 13A and 13B illustrate additional example mapping patterns that may be applied to PRBs configured in subframes according to embodiments of the present disclosure. In particular, FIGS. 13A and 13B illustrate various pilot provisioning alternatives. For example, although the embodiments described above are directed to pilot provisioning in terms of ePHICH, other embodiments may include pilot provisioning in terms of ePCFICH.

Alternatives for pilot provisioning for ePCFICH, ePHICH and ePDCCH in either ePCFICH/ePHICH/ePDCCH PRB n or ePCFICH/ePHICH PRB n shown in FIGS. 5A and 5B. In certain embodiments, the following pilot provisioning for ePDCCH and ePHICH in either ePCFICH/ePHICH/ePDCCH PRB n or ePCFICH/ePHICH PRB n include UE-RS AP 7 and SC-ID 0 is provided as a ePDCCH pilot signal. For example, the ePDCCH pilot signal is either a UE-specific or a UE-group specific RS, which is precoded as in the same way as ePDCCH signal. At the same time, for ePHICH, release 8 (REL-8) CRS are provided as pilot signals. Also, no additional pilot signals are provided exclusively for ePHICH. Certain embodiments of this design may be more advantageous when ePHICH REs are located in the first time slot. This is because CRS in the control region in the first time slot are always available to a UE regardless of whether the subframe type is MBSFN or not; that is, CRS in the PDSCH region are not transmitted when the subframe type is MBSFN. In this case, UE-RS REs for AP9-10 can be used as ePDCCH REs as shown in FIG. 13A. In this case, CRS are used as the ePHICH pilot, ePHICH scrambling is done as in the same way as Rel-8 PHICH, as described below:

The block of modulation symbols z(0), . . . , z(Mₛ−1) shall be symbol-wise multiplied with an orthogonal sequence and scrambled, resulting in a sequence of modulation symbols d(0), . . . , d(M_{symb}−1) according to equation 3.

$$d ( i ) = w ( i mod {N}_{SF}^{PHICH} ) \cdot ( 1 - 2 c ( i ) ) \cdot z ( ⌊ i / {N}_{SF}^{PHICH} ⌋ ) \\ where \\ i = 0 , … , {M}_{symb} - 1 \\ {M}_{symb} = {N}_{SF}^{PHICH} \cdot {M}_{S} \\ {N}_{SF}^{PHICH} = \{ \begin{matrix}4 & normal cyclic prefix \\ 2 & extended cyclic prefix\end{matrix} \qquad [ Eqn . 3 ]$$

and c(i) is a cell-specific scrambling sequence generated according to Section 7.2 in REF1. The scrambling sequence generator shall be initialized with cᵢₙᵢₜ=(└nₛ/2┘+1)·(2N_{ID}^{cell}+1)·2⁹·N_{ID}^{cell} at the start of each subframe.

Embodiments of this design may provide certain advantages. For example, this design provides a way of orthogonally multiplexing the ePHICH and the ePDCCH RS. Also, no additional pilot overhead is introduced in the system for supporting ePHICH.

In certain embodiments, the following pilot provisioning for ePDCCH and ePHICH in either ePCFICH/ePHICH/ePDCCH PRB n or ePCFICH/ePHICH PRB n includes UE-RS AP 7 and a first SC-ID (e.g., 0) is provided as a ePDCCH pilot signal. For example, the ePDCCH pilot signal is either a UE-specific or a UE-group specific RS, which is precoded as in the same way as ePDCCH signal. At the same time, an ePHICH pilot signal is transmitted in the same set of REs and with applying the same orthogonal cover code (OCC) as UE-RS AP8 and the first SC-ID. In this case, the ePHICH pilot signal is not necessarily a UE-specific RS, but is rather a UE group-specific RS, provided for the demodulation of any ePHICHs at least partially transmitted in the PRB n. In other words, every UE receiving at least part of ePHICH in the PRB n may rely on the ePHICH pilot signal transmitted in the PRB n for demodulating the at least part of ePHICH. In this case, UE-RS REs for AP9-10 can be used as ePDCCH REs as shown in FIG. 13A.

Embodiments of this design may provide certain benefits. For example, this design may provide a way of orthogonally multiplexing the ePHICH and the ePDCCH RS. Additionally, no additional REs are used for supporting ePHICH, other than UE-RS AP7-8, which are, in any manner, used for UE-specific ePDCCH.

In certain embodiments, the following pilot provisioning for ePDCCH and ePHICH in either ePCFICH/ePHICH/ePDCCH PRB n or ePCFICH/ePHICH PRB n includes UE-RS APs 7 and 8 are provided as ePDCCH pilot signals. The ePDCCH pilot signal is a UE-specific RS, which is precoded as in the same way as an ePDCCH signal. Multiple ePDCCHs can be MU-MIMO multiplexed for multiple UEs, relying on orthogonal UE-RS APs 7 and 8 and different SC-IDs. At the same time, an ePHICH pilot signal is transmitted in the same set of REs as UE-RS APs 9 and 10. For example, the ePHICH pilot signal is transmitted in the same set of REs and with applying the same OCC as UE-RS AP9 and SC-ID 0. In this case, the ePHICH pilot signal is not necessarily a UE-specific RS, but is rather a UE group-specific RS provided for all the ePHICHs at least partially transmitted in the PRB n. In other words, every UE receiving at least part of ePHICH in the PRB n may rely on the ePHICH pilot signal transmitted in the PRB n for demodulating the at least part of ePHICH.

In another example, the ePHICH pilot signals are UE-specific RS, which is precoded as in the same way as an ePHICH signal. Multiple ePHICHs can be MU-MIMO multiplexed for multiple UEs, relying on orthogonal UE-RS APs 9 and 10 and different SC-IDs.

In another example, the ePHICH pilot signals are cell-specific RS transmitted on UE-RS APs 9 and 10 with scrambling ID 0, to be used for 2-Tx Alamouti transmit diversity (T×D) demodulation.

Embodiments of this design may provide certain benefits. For example, this design may provide a way of orthogonally multiplexing the ePHICH and the ePDCCH RS. Additionally, this design may enable MU-MIMO multiplexing of ePHICH.

It should be noted that the embodiments on ePHICH group formation and ePCFICH formation as described herein are written in terms of ePHICH group formation; nevertheless, the teachings of these embodiments may also be used for ePCFICH formation.

In certain embodiments, the base station configures N ePHICH PRBs as shown in FIGS. 5A and 5B via a radio resource control (RRC) configuration. In receiving the RRC configuration, a UE identifies that a first ePHICH group is composed of N REGs, REG 11, REG21, . . . , REG N1 in the N ePHICH PRBs, where REG 11, . . . , REG N1 are mapped to the same RE locations in all the N ePHICH PRBs according to an ePHICH REG mapping pattern for ePHICH PRB n. Example ePHICH REG mapping patterns can be found in FIGS. 10A-10D and FIGS. 11A-11B. In this case, either a Rel-8 CRS or the UE group specific RS introduced in this disclosure can be provided as an ePHICH pilot for UEs' ePHICH demodulation. For example, when the UE group specific RS is provided, a UE receiving ePHICH in the M ePHICH PRBs should assume that the N ePHICH pilot signals transmitted in the N respective ePHICH PRBs are precoded with different precoders for channel estimation and demodulation for the ePHICH.

In one example, we assume that the ePHICH REG mapping pattern shown in FIG. 10D is used. If the base station configures ePHICH PRBs 1, 2 and 3 to a UE, then the UE identifies three PHICH groups, each composed of 3 REGs: REG 1m, REG 2m and REG 3m, where m ε{1, 2, 3}.

Certain embodiments of this mapping scheme may be beneficial when CRS includes demodulation pilots for ePCFICH, and that a UE need to buffer only up to the 4th OFDM symbol for demodulating PCFICH.

Certain embodiments of this design may provide protection for the ePHICH signals by N-fold frequency diversity gain as a PHICH group is composed of REGs transmitted in N different PRBs. Additionally, as the REGs in a PHICH group are placed in the same RE locations in the ePHICH PRBs, no or relatively small-overhead signaling is required for configuring ePHICH resources.

In certain embodiments, the base station may configure N ePHICH PRBs as shown in FIGS. 5A and 5B via an RRC configuration. Receiving the RRC configuration, a UE may identify that one ePHICH group is composed of M REGs (e.g., REG n1, REG n2, . . . , REG nM) in the same ePHICH PRB, where the REGs are mapped according to an ePHICH REG mapping pattern for ePHICH PRB n. Some Example ePHICH REG mapping patterns can be found in FIG. 10D where M=3, FIG. 10A and FIGS. 11A and 11B where M=2. In this case, UE-specific RS can be provided as an ePHICH pilot for UEs' ePHICH demodulation.

In one example, we assume that the ePHICH REG mapping pattern shown in FIG. 10D is used. If the base station configures ePHICH PRBs 1, 2 and 3 to a UE, then the UE identifies three PHICH groups, each composed of 3 REGs: REG n1, REG n2, REG n3, where n ε{1, 2, 3}.

Certain embodiments of this design may provide frequency-selective precoding gain as a PHICH group is composed of REGs in the same PRB and a UE-specific RS is provided for demodulating an ePHICH. Additionally, given a fixed REG mapping pattern, no or relatively small-overhead signaling is required for configuring ePHICH resources.

PHICHs channels carry one-bit HARQ-ACK/NACK information on an uplink transport block (TB) transmitted on physical uplink shared channel (PUSCH). Finally, the PCFICH channel carries control format information (CFI) indicating the number of OFDM symbols used for the downlink control, such as PDCCH and PHICH. In certain embodiments, a UE is configured to receive either ePHICH or legacy PHICH depending on whether the UL grant having scheduled the associated PUSCH is transmitted in the ePDCCH or in the legacy PDCCH region. For example, a UE in an FDD system is configured to receive ePHICH. When the UE receives the UL grant scheduling the PUSCH in the legacy PDCCH region, the UE is configured to receive legacy PHICH for the PUSCH. On the other hand when the UE receives the UL grant scheduling PUSCH in the ePDCCH region, the UE is configured to receive ePHICH for the PUSCH.

In certain embodiments, a UE is semi-statically configured to receive either ePHICH or legacy PHICH depending on an explicit higher-layer (RRC) configuration. For example, the higher-layer configuration includes a one-bit information element (IE) as shown in Table 4.

TABLE 4
Explicit indication of whether to read ePHICH or PHICH

| The one-bit IE configuring | |
|---|---|
| ePHICH reception | Meaning |
| 0 | Read legacy PHICH for any PUSCH |
| 1 | Read ePHICH for any PUSCH |

Multiple ePHICHs mapped to the same set of resource elements comprise an ePHICH group. In certain embodiments, ePHICHs within the same ePHICH group are separated through different orthogonal sequences. An ePHICH resource may be identified by the index pair (n_{PHICH}^{group},n_{PHICH}^{seq}), where n_{PHICH}^{group} is the ePHICH group number and n_{PHICH}^{seq} is the orthogonal sequence index within the group. The index n_{PHICH}^{group} ranges from 0 to n_{PHICH}^{group}−1 and the number of ePHICH groups n_{PHICH}^{group} is determined by RRC configuration.

In certain embodiments, one HARQ-ACK bit transmitted on one ePHICH in one subframe is BPSK-modulated resulting in a block of complex-valued modulation symbols z(0), . . . , z(Mₛ−1), where Mₛ=M_{bit}_{₌₁}. The block of modulation symbols z(0), . . . , z(Mₛ−1) may be symbol-wise multiplied with an orthogonal sequence and scrambled, resulting in a sequence of modulation symbols d(0), . . . , d(M_{symb}−1) according to Equation 4.

d(i)=w(i mod N_{SF}^{PHICH})·(1−2c(i))·z(└i/N_{SF}^{PHICH}┘) [Eqn 4]

where
i=0, . . . , M_{symb}−1

M_{symb}=N_{SF}^{PHICH}·Mₛ

N_{SF}^{PHICH}4,

wherein for normal cyclic prefix and c(i) is a cell-specific scrambling sequence generated according to Section 7.2 in REF1.

The sequence [w(0) . . . w(N_{SF}^{PHICH}−1)] given by Table 5 where the sequence index n_{PHICH}^{seq} corresponds to the ePHICH number within the ePHICH group.

TABLE 5
Orthogonal sequences [w(0) . . . w(N_{SF}^{PHICH} − 1)] for ePHICH

| | Orthogonal code |
|---|---|
| Sequence | Normal cyclic |
| index | prefix |
| n_{PHICH}^{seq} | N_{SF}^{PHICH} = 4 |
| 0 | [+1 +1 +1 +1] |
| 1 | [+1 −1 +1 −1] |
| 2 | [+1 +1 −1 −1] |
| 3 | [+1 −1 −1 +1] |
| 4 | [+j +j +j +j] |
| 5 | [+j −j +j −j] |
| 6 | [+j +j −j −j] |
| 7 | [+j −j −j +j] |

In certain embodiments, the block of symbols d(0), . . . , d(M_{symb}−1) should be first aligned with resource element group (REG) size, resulting in a block of symbols d⁽⁰⁾(0), . . . , d⁽⁰⁾(c·M_{symb}−1), where c=1 for normal cyclic prefix; and c=2 for extended cyclic prefix.

For normal cyclic prefix, d⁽⁰⁾(i), . . . , d(i), for i=0, . . . , M_{symb}−1.

The block of symbols d⁽⁰⁾(0), . . . , d⁽⁰⁾(c·M_{symb}−1) shall be mapped to layers and precoded, resulting in a block of vectors y(i)=[y⁽⁰⁾(i) . . . y^{(P-1)}(i)]^{T}, i=0, . . . , c·M_{symb}−1, where y^{(p)}(i) represents the signal for antenna port p, p=0, . . . , P−1. The layer mapping and precoding operation depends on the cyclic prefix length and the number of antenna ports used for transmission of the ePHICH.

In certain embodiments, the sequence y̅^{(p)}(0), . . . , y̅^{(p)}(M_{symb}⁽⁰⁾−1) for each of the ePHICH groups is defined by Equation 5:

y̅^{(p)}(n)=Σyᵢ^{(p)}(n) [Eqn. 5]

where the sum is over all ePHICHs in the ePHICH group and yᵢ^{(p)}(n) represents the symbol sequence from the i the ePHICH in the ePHICH group.

In case where the REG size is 4, the length-4 sequence (or an ePHICH quadruplet) y̅^{(p)}(0), . . . , y̅^{(p)}(M_{symb}⁽⁰⁾−1) of each ePHICH mapping group m is mapped to each of the REGs for ePHICH group m. In another case where REG size is 2, the length-2 sequence can be similarly constructed.

In certain embodiments, when either UE group-specific RS or UE-specific RS are used as ePHICH pilots, ePHICH scrambling initialization is determined based at least partly upon at least one of RC (resourceConfig), SC (subframeConfig) and APC (antennaPortCount) of a CSI-RS RRC configuration REF4.

In this particular embodiment, the scrambling and spreading of PHICH information bits z(0), . . . , z(Mₛ−1), where for example Ms=1, are done according to the following: z(0), . . . , z(Mₛ−1) shall be symbol-wise multiplied with an orthogonal sequence and scrambled, resulting in a sequence of modulation symbols d(0), . . . , d(M_{symb}−1) according to Equation 6:

$$d ( i ) = w ( i mod {N}_{SF}^{PHICH} ) \cdot ( 1 - 2 c ( i ) ) \cdot z ( ⌊ i / {N}_{SF}^{PHICH} ⌋ ) \\ where \\ i = 0 , … , {M}_{symb} - 1 \\ {M}_{symb} = {N}_{SF}^{PHICH} \cdot {M}_{S} \\ {N}_{SF}^{PHICH} = \{ \begin{matrix}4 & normal cyclic prefix \\ 2 & extended cyclic prefix\end{matrix} \qquad [ Eqn . 6 ]$$

and c(i) is a cell-specific scrambling sequence generated according to Section 7.2 in REF1.

In one alternative, the scrambling sequence generator may be initialized with cᵢₙᵢₜ=(└nₛ/2┘+1)·(2N_{ID}^{cell}+1)·2⁹·n_{SCID,2} at the start of each subframe. n_{SCID,2} is determined as a function of a few alternative equations for n_{SCID,2} are listed below, where ñ_{SCID,2} is a function of RC, SC and APC: n_{SCID,2}=X, and n_{SCID,2}=ñ_{SCID,2}·(1+X).

Here, the multiplication of (1+X) expands the possible values for the UE-RS scrambling initialization cᵢₙᵢₜ.

For n_{SCID,2}=ñ_{SCID,2}·X, the multiplication of X expands the possible values for the UE-RS scrambling initialization cᵢₙᵢₜ, and at the same time gives flexibility of turning off the soft-cell partitioning.

For n_{SCID,2}=ñ_{SCID,2}+X, the addition of X lets the base station have flexibility to choose the UE-RS scrambling initialization Cᵢₙᵢₜ e.g., to intentionally configure a different UE-RS scrambling to a UE than the one configured by the CSI-RS configuration.

In one alternative, X is an RRC configured parameter for determining transmission-point-specific scrambling for ePHICH, UL RS, DL RS and so on; in another alternative, X is not signaled, and is fixed to be 0.

Some examples of determining ñ_{SCID,2} may include: ñ_{SCID,2}=g(RC), ñ_{SCID,2}=g(RC)·(I_{CSI-RS} mod 5), ñ_{SCID,2}=g(RC)·(I_{CSI-RS} mod 80), and ñ_{SCID,2}=g(RC)·Δ_{CSI-RS}. In these examples, Δ_{CSI-RS} is CSI-RS subframe offset derived from I_{CSI-RS}=SC using Table 2 shown above.

Furthermore, some alternatives of determining the function g(RC) may include: and g(RC)=RC g(RC)=RC mod 10.

In another alternative, the scrambling sequence generator shall be initialized with cᵢₙᵢₜ=(└nₛ/2┘+1)·(2N_{v-ID}^{cell}+1)·2⁹·N_{v-ID}^{cell} at the start of each subframe. Here, N_{v-ID}^{cell} is RRC configured virtual cell ID.

ePHICH resource indexing in case UE-specific RS is used for ePHICH demodulation

In certain embodiments, as shown in FIG. 13B, UE-RS APs 7 and 8 are provided as ePDCCH pilot signals, and UE-RS APs 9 and 10 are provided as UE-specific ePHICH pilot signals. An ePHICH resource (nPHICH) as well as an ePDCCH resource (nCCE) is uniquely determined by AP number, SCID, and PRB number.

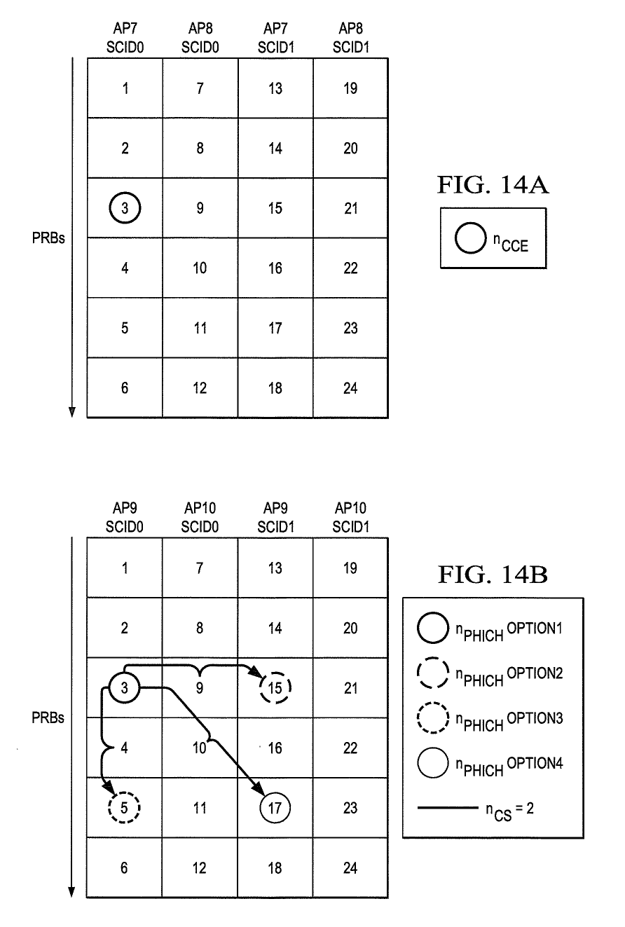

FIGS. 14A and 14B illustrate example ePDCCH and ePHICH resource numbering schemes according to embodiments of the present disclosure. Similar to the embodiments of FIG. 8A through 8D, the PRBs are configured as ePDCCH/ePHICH PRBs. For a given (AP, SCID), the resource number sequentially increases as PRB number increases. At the same time, the resource number keeps sequentially increasing from the top of the next column associated with a different (AP, SCID) pair.

In one alternative, the ePHICH resource triple (AP, SCID, PRB) is determined at least partly upon the PRB number of an ePDCCH UL grant having scheduled the associated PUSCH of the ePHICH and the demodulation reference signal cyclic shift (CS) number which has been indicated in the UL grant. Some example mapping functions from the ePDCCH PRB number and the CS number (nCS) to the ePHICH resource triple are illustrated in FIGS. 14A and 14B and also listed below:

nPHICH=nCCE

nPHICH=nCCE+(nCS mod 4)·NPRB

nPHICH=nCCE+(nCS mod NPRB)

nPHICH=nCCE+(nCS mod NPRB)+(nCS mod 4)·NPRB

Here, NPRB is the total number of PRBs allocated to ePDCCH, and NPRB=6 in FIGS. 14A and 14B.

Once nPHICH is determined, the ePHICH resource triple can be found as illustrated in FIGS. 14A and 14B. For example, when nPHICH=15, (AP, SCID, PRB)=(9, 1, 3).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A base station configured for communication with a plurality of subscriber stations, the base station configured to:
select one or more physical resource blocks (PRBs) for mapping an enhanced physical data control channel (ePDCCH) and at least one of an enhanced physical downlink control format indicator channel (ePCFICH), an enhanced physical hybrid-ARQ indicator channel (ePHICH);
map a number of resource element groups (REGs) for the at least one of the ePCFICH or the ePHICH onto a first set of REs in each of one or more PRBs according to a mapping pattern;
map a number of REGs for the ePDCCH onto a second set of REs in each of the one or more PRBs, wherein the first set of REs and the second set of REs do not have a common RE; and
transmit the one or more PRBs to at least one subscriber station.

2. The base station of claim 1, wherein the at least one of the ePCFICH or the ePHICH each has a REG size that is different from the REG size of the ePDCCH.

3. The base station of claim 1, wherein the mapping pattern comprises REs on each of at least one of subcarriers 0, 4, 5, 7, and 10 on at least two adjacent orthogonal frequency division multiplexing (OFDM) symbols containing a equipment-reference signal (UE-RS) in each of the one or more PRBs are mapped onto each of the number of REGs for the at least one of the ePCFICH and the ePHICH.

4. The base station of claim 1, wherein the mapping pattern comprises REs corresponding to at least one N_{AP}-port CSI-RS pattern conforming to the 3rd Generation Partnership Project (3GPP) LTE Release-10 specification in each of the one or more PRBs are mapped onto the number of REGs for the at least one of the ePCFICH and the ePHICH.

5. The base station of claim 1, wherein the base station is configured to:
select UE-RS antenna port (AP) 7 and SC-ID 0 to be used for demodulation of the ePDCCH in each of the one or more PRBs, and select release 8 (REL-8) CRS to be used for demodulation of at least one of the ePHICH and the ePCFICH in each of the one or more PRBs.

6. The base station of claim 1, wherein the base station is configured to:
select UE-RS AP 7 and a first SC-ID to be used for demodulation of the ePDCCH in each of the one or more PRBs, and select UE-RS AP 8 and the first SC-ID to be used for demodulation of at least one of the ePHICH and the ePCFICH in each of the one or more PRBs.

7. The base station of claim 1, wherein the base station is configured to:
select UE-RS APs 7 and 8 to be used for demodulation of the ePDCCH in each of the one or more PRBs, and select UE-RS APs 9 and 10 be used for demodulation of at least one of the ePHICH and the ePCFICH in each of the one or more PRBs.

8. The base station of claim 1, wherein the base station is configured to:
transmit an HARQ-ACK in response to a PUSCH on the ePHICH when the base station has transmitted an uplink grant scheduling the PUSCH on the ePDCCH; and
transmit the HARQ-ACK on the PHICH when the base station has transmitted the uplink grant on the PDCCH.

9. For use in a subscriber station configured to communicate with a plurality of base stations in a wireless network, a method comprising:
receiving one or more physical resource blocks (PRBs) from a base station, the PRBs comprising an enhanced physical data control channel (ePDCCH) and at least one of an enhanced physical downlink control format indicator channel (ePCFICH), an enhanced physical hybrid-ARQ indicator channel (ePHICH),
wherein a number of resource element groups (REGs) for the at least one of the ePCFICH or the ePHICH are mapped onto a first set of REs in each of one or more PRBs according to a mapping pattern, and
wherein a number of REGs for the ePDCCH are mapped onto a second set of REs in each of the one or more PRBs, wherein the first set of REs and the second set of REs do not have a common RE.

10. The method of claim 9, wherein the at least one of the ePCFICH or the ePHICH each has a REG size that is different from the REG size of the ePDCCH.

11. The method of claim 9, wherein the mapping pattern comprises REs on each of at least one of subcarriers 0, 4, 5, 7, and 10 on at least two adjacent orthogonal frequency division multiplexing (OFDM) symbols containing a equipment-reference signal (UE-RS) in each of the one or more PRBs are mapped onto each of the number of REGs for the at least one of the ePCFICH and the ePHICH.

12. The method of claim 9, wherein the mapping pattern comprises REs corresponding to at least one N_{AP}-port CSI-RS pattern conforming to the 3rd Generation Partnership Project (3GPP) LTE Release-10 specification in each of the one or more PRBs are mapped onto the number of REGs for the at least one of the ePCFICH and the ePHICH.

13. The method of claim 9, further comprising:
using UE-RS antenna port (AP) 7 and SC-ID 0 for demodulation of the ePDCCH in each of the one or more PRBs, and 3GPP LTE Release 8 (REL-8) is configured to be used for demodulation of at least one of the ePHICH and the ePCFICH in each of the one or more PRBs.

14. The method of claim 9, further comprising:
using UE-RS AP 7 and a first SC-ID for demodulation of the ePDCCH in each of the one or more PRBs, and a UE-RS AP 8 and the first SC-ID is configured to be used for demodulation of at least one of the ePHICH and the ePCFICH in each of the one or more PRBs.

15. The method of claim 9, further comprising:
using UE-RS APs 7 and 8 for demodulation of the ePDCCH in each of the one or more PRBs, and UE-RS APs 9 and 10 are configured to be used for demodulation of at least one of the ePHICH and the ePCFICH in each of the one or more PRBs.

16. The method of claim 9, further comprising:
receiving an HARQ-ACK generated by the base station in response to a PUSCH on the ePHICH when an uplink grant scheduling the PUSCH is received on the ePDCCH; and
receiving the HARQ-ACK on the PHICH when the base station has transmitted the uplink grant on the PDCCH.

17. A subscriber station configured to communicate with a plurality of base stations in a wireless network, the subscriber station configured to:
receive one or more physical resource blocks (PRBs) from a base station, the PRBs comprising an enhanced physical data control channel (ePDCCH) and at least one of an enhanced physical downlink control format indicator channel (ePCFICH), an enhanced physical hybrid-ARQ indicator channel (ePHICH),
wherein a number of resource element groups (REGs) for the at least one of the ePCFICH or the ePHICH are mapped onto a first set of REs in each of one or more PRBs according to a mapping pattern, and
wherein a number of REGs for the ePDCCH are mapped onto a second set of REs in each of the one or more PRBs, wherein the first set of REs and the second set of REs do not have a common RE.

18. The subscriber station of claim 17, wherein the at least one of the ePCFICH or the ePHICH each has a REG size that is different from the REG size of the ePDCCH.

19. The subscriber station of claim 17, wherein the mapping pattern comprises REs on each of at least one of subcarriers 0, 4, 5, 7, and 10 on at least two adjacent orthogonal frequency division multiplexing (OFDM) symbols containing a equipment-reference signal (UE-RS) in each of the one or more PRBs are mapped onto each of the number of REGs for the at least one of the ePCFICH and the ePHICH.

20. The subscriber station of claim 17, wherein the mapping pattern comprises REs corresponding to at least one N_{AP}-port CSI-RS pattern conforming to the 3rd Generation Partnership Project (3GPP) LTE Release-10 specification in each of the one or more PRBs are mapped onto the number of REGs for the at least one of the ePCFICH and the ePHICH.

21. The subscriber station of claim 17, a UE-RS antenna port (AP) 7 and SC-ID 0 is configured to be used for demodulation of the ePDCCH in each of the one or more PRBs, and 3GPP LTE Release 8 (REL-8) is configured to be used for demodulation of at least one of the ePHICH and the ePCFICH in each of the one or more PRBs.

22. The subscriber station of claim 17, a UE-RS AP 7 and a first SC-ID is configured to be used for demodulation of the ePDCCH in each of the one or more PRBs, and a UE-RS AP 8 and the first SC-ID is configured to be used for demodulation of at least one of the ePHICH and the ePCFICH in each of the one or more PRBs.

23. The subscriber station of claim 17, UE-RS APs 7 and 8 are configured to be used for demodulation of the ePDCCH in each of the one or more PRBs, and UE-RS APs 9 and 10 are configured to be used for demodulation of at least one of the ePHICH and the ePCFICH in each of the one or more PRBs.

24. The subscriber station of claim 17, wherein the subscriber station is configured to:
receive an HARQ-ACK generated by the base station in response to a PUSCH on the ePHICH when an uplink grant scheduling the PUSCH is received on the ePDCCH; and
receive the HARQ-ACK on the PHICH when the base station has transmitted the uplink grant on the PDCCH.
